(19) United States
(12) Patent Application Publication
(10) Pub. No.: US 2007/0132396 A1
(43) Pub. Date: Jun. 14, 2007

(54) Crevice-minimized metal halide burner with ceramic discharge vessel

(76) Inventors: Nicasius G. T. Van Gennip, Heeze (NL); Josephus Christiaan Maria Hendricx, Geldrop (NL); Giovanna Wagenaar, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/575,287

(22) PCT Filed: Oct. 11, 2004
(86) PCT No.: PCT/IB04/52041

§ 371 Date: Apr. 11, 2006

(30) Foreign Application Priority Data
Oct. 17, 2003 (EP) 03103851.6

(51) Int. Cl. H01J 61/36

(52) U.S. Cl. 313/625

(57) ABSTRACT

The present invention relates to a metal halide burner with ceramnic discharge vessel, a lamp with said burner, and a method for manufacturing said burner with one discharge vessel having two end parts (2a, 2b) each with one end opening (3a, 3b), a filling (8), two end closure constructions (4a, 4b) for closing said end openings (3a, 3b), and crevices (7a, 7b) between the end openings (3a, 3b) and the end closure constructions (4a, 4b), wherein the first end closure construction (4a) differs from said second end closure construction (4b) in at least shape, type of material of the components and/or arrangement of components; and/or the shape of said first crevice (7a) differs from the shape of said second crevice (7b); and/or the first end part (2a) differs from the second end part (2b) in shape, type of material of one component, and/or the arrangement of components; so that an asymmetric ceramic metal halide burner is achieved.

The present invention relates to a metal halide burner with ceramic discharge vessel—also known as ceramic discharge metal halide burner or ceramic metal halide burner—and a lamp having a ceramic metal halide burner comprising one discharge vessel for accommodating a filling having two end parts each having one end opening, a filling, a first and a second end closure construction having several components for closing said end openings, and a first and a second crevice between the end openings and the end closure constructions and a method for manufacturing such a burner.

More precisely, said invention relates to a ceramic metal halide lamp comprising a discharge vessel having a ceramic wall, which encloses a discharge space characterized by an internal diameter. Said discharge vessel is closed by means of end closure constructions, where electrodes are arranged therein, whose tips have a mutual spacing between which a discharge is maintained. Said electrode is connected to an electric current conductor by means of a feed through element, which protrudes into said end closure device with a tight fit, and is connected thereto in a gas tight manner by help of connection means. Said discharge vessel is filled with an ionisable filling. Said filling comprises inert gas such as for instance Xenon-Xe-, and ionisable salts. Said invention relates to the design of the ceramic metal halide burner, more precisely to the design or setup of said end closure construction and for the end part of the discharge vessel, i.e. to the design of the feed through, the discharge vessel, and/or the connection means, where the feed through is gas tight connected to the discharge vessel.

Metal halide lamps are found in many applications, such as for instance in a motor vehicle as an automotive lamp used for head lighting applications.

Ceramic metal halide lamps and related manufacturing processes are known from a prior art. Nevertheless, it is still necessary to provide a ceramic metal halide lamp and manufacturing process thereof avoiding the drawbacks known from said prior art. Due to the high pressure filling of ceramic metal halide burner, gas tight closing said high-pressure discharge vessel causes several problems. Heating said discharge vessel for gas tight sealing leads said internal filling to expand or evaporate. As a result, filling gas expansion causes a bad quality seal, and filling salts evaporation gives unwanted lamp characteristics. Said seal is then characterized in that it ends up with an irreproducible length, since expanding gas tends to push it outwards from said discharge vessel. Moreover said seal will contain defects, such as gas bubbles, and/or small channels along which the gas can escape leading to cracks, which weakens the seal mechanical strength, leading to leakage.

In order to prevent the expansion or evaporation of said filling, several attempts to find alternative sealing processes and designs have been made.

WO 00/67294 describes a high-pressure discharge lamp, more precisely a metal halide one, with a very small, very high-pressure filled vessel, surrounded by a gas filled outer bulb.

Said lamp has the advantage of having a discharge vessel with very compact dimensions, which makes it highly suitable for head lighting applications in motor vehicles. Thanks to the discharge vessel internal diameter, small compared to the electrode spacing, the discharge arc is sufficiently straight, and its light emitting surface sufficiently sharply limited, so that it can be used as a light source in an automotive headlamp, especially in a headlamp with a complex-shape reflector.

One drawback of the known lamp is however a relative large loss of the initial filling while heating up said lamp's discharge vessel as gas-tight closing it. It leads to a wrong colour point setting and to colour instability. If the amount of loss of the initial filling is relatively large, the quantity of initial filling which is lost tends to vary. If the initial filling pressure loss is not exactly equal for all lamps in production it will lead to undesirable differences in lamp characteristics. Further drawbacks also comprise an irreproducible initial sealing ceramic length and a bad sealant quality having bubbles and channels while gas tight closing said discharge vessel, a sealing ceramic cracking behaviour within the high lamp-operating temperature range, which leads to a leaky seal. Furthermore said discharge vessel end construction design comprise a wide clearance, between said feed through outer surface and the ceramic plug inner wall, which leads to colour instability. These drawbacks are caused by the current sealing process, or are related to the current sealing design. Said process is actually heating far too much surface of said filled discharge vessel, and said design is leaving far too much clearance between said feed through and said ceramic plug.

U.S. Pat. No. 5,810,635 A1 describes a ceramic discharge vessel for a high-pressure discharge lamp, which comprises a pin-like feed through inserted into a plug, made from a thermo mechanically matching composite material. The feed through has been sintered directly into the plug. Additionally, said feed through has been sealed to the plug, by covering its surrounding area facing away from the discharge vessel with a ceramic sealing material. The main purpose of the invention is to obtain long-time gas tightness, whereby it is firstly ensured by the tight fit of the feed through sintered into the composite plug, and later ensured by sealing ceramic material facing away from the discharge vessel as the sintering fit gets loose. The sequencing of the ceramic discharge vessel closure is of a primary importance: first the composite plug with sintered feed through is sintered at the end of the vessel, and then the filling is performed through a small hole either located in one tubular-shaped feed through or through a discharge vessel side hole. Eventually the small aperture is closed. This invention is addressing the issues of sealing frit length, clearance between feed through and the ceramic plug, and heating a filled discharge vessel while closing the plug.

It turns out, however, that the end construction design and process mentioned in U.S. Pat. No. 5,810,635 A1 has two major drawbacks. Firstly, the use of a tubular-shaped feed through design, or a side-pierced discharge vessel design, through which the filling could be introduced to the discharge cavity, is very difficult in a very small and compact burner. Moreover, a tubular feed through design is very difficult as one of its parts is usually made of a thin composite material such as cermet. Consequently, the proposed process sequencing related to the described lamp manufacture, that is to say closing the discharge vessel first and then filling it, cannot be applied for very compact burners.

The lamp previously mentioned has the disadvantage that it can form a crevice between the hole in the cermet and the stopper due to an insufficient sealing length, which leads to colour instabilities in case of application of specific salts. Another drawback of the end construction given in U.S. Pat. No. 5,810,635 is, that the sealing frit is attacked in the crevice during the operation of the burner, especially if this sealing frit fills up the whole hole. A third drawback of the given end construction is the generation of cracks leading to small crevices between the feed through and the cermet due to thermo mechanical mismatching materials causing burner leakage. Another reason for a leaky sealant is for instance when the sintering tight fit gets loose.

Gas-tight closing said discharge vessel causes several problems.

One object of the present invention is to provide a metal halide burner with ceramic discharge vessel and a metal halide lamp wherein the aforementioned drawbacks are alleviated. In order to achieve this goal, the proposed burner design, the materials used for manufacturing said burner, and the method of manufacturing said burner is aiming at reducing the crevice between a feed through and an end part and in reducing the building of salt deposits at unwanted locations.

Another aspect is, that after the feed through has been arranged in the end opening a crevice remains, which acts as coldest spot, along which de-mixed salts can condensate and form corrosive salt pools, for instance at the extremity of said crevice near the seal. Such crevices then encourage colour instability and seal corrosion.

However, said “coldest spot” is encouraging the condensation of the de-mixed ionisable salt filling. The longer the crevice along the burner main symmetry axis, the further the coldest spot from the relatively hot discharge vessel, therefore the lower the temperature of the coldest spot.

De-mixed ionisable salts filling condensation negatively affects the colour co-ordinates and colour stability of the lamp. Furthermore, one of the corrosive salt pools, located in the crevice against the seal, negatively affects the long-time gas-tightness of the high-pressure discharge vessel. Therefore, lifetime of such a lamp is unsatisfactory. However the main problem of de-mixing salts is due to large crevices, that during lamp operation the salt composition at different places in the burner varies.

In order to overcome the drawbacks known from a prior art, it is necessary to provide a ceramic metal halide burner design, which is crevice-minimized, i.e. which has improved chemical resistance properties and reduced room for salts condensation.

Therefore it is an object of the present invention to provide a corrosion resistant ceramic metal halide burner.

It is a further object of the present invention to provide a crevice-minimized ceramic metal halide burner.

All issues are addressed through a ceramic metal halide burner with one discharge vessel for accommodating a filling with two end parts each having one end opening, a filling, a first and a second crevice between the end openings and the end closure constructions, wherein the first end closure construction differs from said second end closure construction in at least geometry, diameter, length, circumference, cross-sectional area, surface, volume, type of material of the components and/or arrangement of components; and/or the geometry, diameter, length, circumference, cross-sectional area, surface, volume of said first crevice differs from the geometry, diameter, length, circumference, cross-sectional area, surface, volume of said second crevice; and/or the first end part differs from the second end part in geometry, diameter, length, circumference, cross-sectional area, surface, volume, type of material of one component, and/or the arrangement of components; so that an asymmetric ceramic metal halide burner is achieved.

According to the present invention the shape of the end closure construction, the crevice, and or the end parts comprises all geometries and/or construction parameters of a body including diameter, length, circumference, shape of the cross-sectional area, form of area, surface, volume, etc.

Said ceramic metal halide burner according to the present invention comprises: at least one discharge vessel for accommodating a filling comprising as components: i) a first end part having a first through-going end opening, ii) a second end part, having a second through-going end opening, and iii) a discharge cavity connected to both end openings, a filling, a first end closure construction for closing said first end opening, comprising as components i) a first feed through and ii) a first sealant, and a second end closure construction for closing said second end opening, comprising as components: i) a second feed through and ii) a second sealant, whereby each feed through is at least with its mid-section surrounded by an end opening forming a crevice, whereby said feed through extends into the discharge cavity, whereby said crevice is at least partly filled with a sealant, so that a gas tight sealed ceramic metal halide burner is achieved, wherein the first end closure construction differs from said second end closure construction in at least geometry, diameter, length, circumference, cross-sectional area, surface, volume, type of material of the components and/or arrangement of components; and/or the geometry, diameter, length, circumference, cross-sectional area, surface, volume of said first crevice differs from the geometry, diameter, length, circumference, cross-sectional area, surface, volume of said second crevice; and/or the first end part differs from the second end part in geometry, diameter, length, circumference, cross-sectional area, surface, volume, type of material of one component, and/or the arrangement of components; so that an asymmetric ceramic metal halide burner is achieved.

One advantage of the present invention is, that due to the asymmetry of the burner the building of salt deposits can be directed to one side of the burner. Thus the first side has a different design compared to the design of the second side so that the first side is suitable for locating possible salt deposits in the area of this side.

Asymmetric in the sense of the present invention means, that the first side of the burner, which comprises a first end part and a first end closure construction is different from the second side of the burner, which comprises a second end part and a second end closure construction. The difference can be determined by several parameters such as shape, form, material, and arrangement.

Usually both sides of a burner are formed symmetrically, that is symmetrically to a mid-plane, which cuts the burner into two equal half's. The burner has also a rotational symmetry around its centerline.

Of course conventional burners can have a kind of asymmetry due to tolerances and unplanned deviations in the manufacturing process or in differences in the material. That of course is an unplanned asymmetry. Asymmetric in the sense of the present invention means a planned asymmetry, which leads to planned different conditions at the two sides of the burner.

To achieve a discharge arc inside a discharge vessel the ceramic metal halide burner comprises two feed throughs. Both feed throughs comprises an electrode located at one end thereof, facing each other for achieving said discharge arc between them. The electrodes extend into the discharge vessel. The rod of the feed through to which the electrode is connected can also extend into the discharge vessel. However, depending on the applied material for the feed through it can also be withdrawn into the end part, which can be an extended plug. Parameters for the arrangement of the position of the feed through are temperature and corresponding chemical resistance to the lamp filling of the applied material of the feed through.

A filling is needed, to achieve said discharge arc. The filling comprises a noble gas as for example Xe and salts, preferably iodides. In order to prevent the filling from leaving the vessel, a suitable end closure construction has to be provided. For that reason, the discharge vessel has two end parts, each with a through-going end opening for accommodating the feed throughs therein, whereby the end parts are closed by said end closure constructions. Between the end parts and the feed throughs usually a clearance results due to manufacturing tolerances and for an easier handling of arranging the feed through into the end opening. That clearance, gap or crevice has to be gas-tight closed in order to provide a gas-tight discharge burner. Therefore the end closure construction comprises besides the two feed throughs at least one sealant for each crevice or clearance. During a sealing process the initial unfilled crevice is filled by said sealant.

The sealing process and the achieving of the discharge arc is done at high temperatures, so that the filling, which has a pressure of about 8 bar to 25 bar at room temperature, tries to expand towards the ends of the discharge vessel. The temperature at the ends of the discharge vessel during operation is lower than at the electrodes or at the discharge arc. Therefore the filling tends to build deposits at the colder ends at both sides of the discharge vessel, which leads to the aforementioned disadvantages.

An asymmetric ceramic metal halide burner according to the present invention has the advantage, that the salt is at least mainly or completely to be kept at one side of the discharge vessel, that is the area where the end part and the end closure construction is located, due to the different conditions at the two sides of the burner. So the salt will always lay down at a predetermined, defined position, which is the coldest spot in the end part area at one predetermined side of the discharge vessel. This side, where the salt will lay down, therefore has a different design than the other side, where no or less salt will lay down. Preferably the side, where the salt will lay down has to be the side with a minimized crevice or without crevice. The side, where no salt will lay down may have a small crevice, which makes it easier to build. To prevent the building of salt deposits at one side of the burner the lowest temperature in the small crevice at the side where no or less salt will lay down has to be higher than the temperature of the coldest spot of the burner.

The asymmetric design of the burner results in a more colour stable burner, which leads to an increased durability. Furthermore a larger variety of salts beside NaPr iodide could be used for filling, for example NaCe iodide, which has a higher efficacy but is less colour stable.

A further advantage is, that different materials could be used as sealants, which are more suitable for gas tight sealing and have higher resistance against the aggressive salt than standard sealing frits but melts at high temperatures and need longer sealing times.

Preferably the crevices, each having at least an unfilled portion and a filled portion differ in that after the sealing process the volume of the unfilled portion of the first crevice leading to the discharge cavity is smaller than the volume of the corresponding unfilled portion of the second crevice; and/or after the sealing process the cross-sectional area of said unfilled portion of the first crevice is smaller than the corresponding cross-sectional area of the unfilled portion oft the second crevice; and/or after the sealing process the length of the unfilled portion of the first crevice is shorter than the length of the corresponding unfilled portion of the second crevice.

Preferably the volume of the unfilled portion of the first crevice is in the range from ≧0.0 mm³ to ≦0.25 mm³, more preferably in the range from ≧0.00973 mm³ to ≦0.0389 mm³, and most preferably from ≧0.01950 mm³ to ≦0.097 mm³.

Preferably the volume of the unfilled portion of the second crevice is in the range from ≧0.0 mm³ to ≦0.5 mm³, more preferably from ≧0.01950 mm³ to ≦0.04850 mm³, and most preferably from ≧0.03890 mm³ to ≦0.19980 mm³.

The cross-sectional area of one crevice is smaller than the cross-sectional area of the other crevice, preferably the cross-sectional area of one crevice is 0.1% to 15.0%, preferably 0.5% to 10.0%, and most preferably 1.0% to 5.0% larger than the cross-sectional area of the other crevice; and/or the outer diameter of one crevice is smaller than the outer diameter of the other crevice, preferably the outer diameter of the one crevice is 0.1% to 15%, more preferably 0.5% to 10%, and most preferably 1.0% to 15% larger than the outer diameter of the other crevice.

The length of the unfilled portion of the first crevice is smaller than the length of the second crevice, preferably the length of the unfilled portion of the first crevice is in the range from ≧0.0 mm to ≦3.0 mm, more preferably from ≧0.5 mm to ≦2.0 mm, and most preferably from ≧1.0 mm to ≦1.5 mm.

The length of the unfilled portion of the second crevice is larger than the length of the unfilled portion of the first crevice; preferably the length of the second crevice is in the range from ≧0.0 mm to ≦6.0 mm, more preferably from ≧0.5 mm to ≦4.0 mm, and most preferably from ≧1.0 mm to ≦2.0 mm.

The crevice is the space between end closure construction and end part After the manufacturing process of the burner the crevice is filled with a sealant by a sealing process. Due to technical reasons both crevices cannot be filled to 100% by said sealant so that after the sealing process an unfilled portion of the crevice and a filled portion of the crevice results. Their volumes, their cross-sectional areas, and/or their dimensions can describe both portions of the crevice.

The crevice can have any form with a defined volume. The volume of the crevice at the side, where the salt will lay down has to be as small as possible to avoid for example colour instability. Therefore the unfilled portion of the crevice at the side where the salt lay down, in the following referred to as first side, has a volume around 0 mm³. The ideal situation would of course be, that the volume of the unfilled crevice at the second side—that is the side, where no or less salt will lay down—is also around or near 0 mm³. But because of the sealing process that will not be possible in all cases.

Aside its volume, the crevices can be described by their cross-sectional areas which could vary along the centerline of the burner.

The cross-sectional area of the crevice depends on the through-going opening of the end part and the feed through being arranged in said end part or to be more precisely in the end opening of the end part. Both, feed through and through-going end opening of the end part can have a cross-sectional area of any form and therefore the cross-sectional area of the crevice can have any cross-sectional area resulting from the cross-sectional areas of the feed through and the end opening. Preferably the cross-sectional areas of the opening and the feed through are circular, so that the cross-sectional area of the crevice has an annular cross-sectional area. Preferably the cross-sectional area of the crevice at the first side and the second side is ≧0 mm². Due to manufacturing and/or technical reasons such as tolerances for inserting the feed through into the end opening that is not possible. Thus cross-sectional area of the crevice is defined according to the formula (π·R₂²−π·R₁²), whereby R₂ is the radius of the circular cross-sectional area of the end opening of the end part and R₁ is the outer radius of the cross-sectional area of the feed through.

Preferably the maximum diameter of the first feed through is between ≧100 μm and ≦1000 μm, more preferably between ≧200 μm and ≦600 μm, and most preferably between ≧300 μm and ≦560 μm. For a 30 W automotive burner the feed through diameter for example is in the range of ≧250 μm and ≦500 μm.

The difference of R₂ minus R₁ is preferably between ≧0 μm and ≦50 μm, more preferably between ≧5 μm and ≦25 μm, and most preferably between ≧10 μm and ≦15 μm.

For using sealing frits for the sealing process the difference of R₂ minus R₁ is preferably in the range from ≧10 μm to ≦40 μm, more preferably around 30 μm.

The cross-sectional area can vary along the axis of the feed through and/or the axis of the end opening of the end part. However, preferably the cross-sectional area is constant along the axis.

Therefore the crevice can be defined by its outer diameter, that is the diameter of the through-going end opening of the end part and/or its inner diameter, that is the outer diameter of the feed through.

The diameters of the first crevice—that one on the first side of the burner, where salt will lay down—and the second crevice—that one on the second side of the burner, where no salt will lay down—can of course have identically diameters. The diameter of the second crevice can even be larger than the diameter of the first crevice. To avoid colour instabilities, the diameters of the crevices are as small as possible.

Also the diameters of the annular-shaped crevices can vary along the axis of the opening and/or the feed through. Preferably the diameters are constant along the axis. Therefore its length can define the crevice. Preferably the length of the first crevice is shorter than the length of the second crevice. In a best mode the length of the first crevice is around 0 μm.

Although a first crevice length of around 0 μm would be best, a length of maximum 1.5 mm is acceptable due to the high temperatures in the area close to the connection between W electrode and Mo or Re rod part of the electrode-feed through combination. Even at high temperatures salt might not creep into this small crevice.

In the case, the volume could not be exact measured; the volumes mentioned in this invention can be calculated as described in the following. Therefore an approximation is necessary, which reduces the realistic volume to the volume of an ideal and/or theoretically body, for which the parameters could be measured.

According to the abovementioned the crevices have a mainly tubular shape. Thus the volume of the crevices can be calculated by the formula l_{c}·(π·R₂²−π·R₁²), whereby l_{c} is the length of the crevice, R₂ is the outer radius of the crevice, and R₁ is the inner radius of the crevice. In a first embodiment the volume of the first crevice is 0 mm³ and the volume of the second crevice, therefore that a volume of 0 mm³ is technically not possible, is 0.0194778 mm³ (R₁=0.15 mm, R₂=0.16 mm, and l_{c}=2 mm). In a second embodiment of the present invention the volume of the first crevice is 0.0201 mm³ (R₁=0.15 mm, R₂=0.17 mm, and l_{c}=1 mm) and the volume of the second crevice is 0.0804 mm³ (R₁=0.15 mm, R₂=0.17 mm, l_{c}=4 mm) that is a ratio of 25%.

The length could be easily measured for example by means of x-ray, by microscope and/or other methods of measurement used in such cases like measuring with the bare eye—cause the discharge vessel is in the area of the crevice transparent—or by cutting the burner in longitudinal direction and grinding the cut.

In another embodiment of the present invention the sealants differ in that after the sealing process the position of the first sealant located inside the first crevice is arranged more closely to the first inner end opening of the first end opening compared with the position of the second sealant inside the second crevice, preferably the distance between the first sealant and the first inner end opening is in the range from ≧0.0 mm to ≦1.5 mm for example 0.1 mm, more preferably from ≧0.3 mm to ≦1.0 mm for example 0.4 mm, and most preferably from ≧0.5 mm to ≦0.7 mm for example 0.6 mm.

For achieving a crevice-less or at least a crevice-minimized ceramic metal halide burner, the sealant filling the crevice has to be located as close as possible to the inner end opening. The inner end opening is the part of the end opening where the end opening disembogues into the discharge cavity. For gas tight sealing the burner it is not necessary for the sealant to fill the whole crevice in longitudinal or axial direction. For achieving a gas tight burner the sealant has to fill the crevice completely in radial direction that is the sealant has to contact the corresponding feed through and the corresponding end part without interruption. To minimize that part of the crevice facing towards the discharge cavity the sealant has to be located as close as possible to the inner end opening. At the first side, that is the side where salt will lay down, the sealant has to be located as close as possible to the inner end opening, that is in a distance smaller than 1.5 mm towards the inner end opening. Preferably the surface of the sealant facing towards the discharge cavity is located closer than 1.5 mm towards the corresponding inner end opening. The distance between the second sealant, or to be more precisely the surface of the second sealant facing towards the discharge cavity and the second inner end opening should be no greater than 6.0 mm.

Preferably the sealants differ in that the first sealant is of a material selected from the group comprising metals or a metal alloys like PtNb or PtZr and/or the second sealant is of a material selected from the group comprising the material of a known sealing frit, a sealant frit with a higher content of Al₂O₃ powder than the known sealing frit, Al₂O₃—Dy₂O₃—SiO₂, and/or the filling level of the first sealant after the sealing process inside the first crevice is larger than the filling level of the second sealant inside the second crevice.

Preferably the filling level of the first crevice is from ≧0.1% to ≦35%, more preferably from ≧1% to ≦20%, and most preferably from ≧2% to ≦15% larger than the filling level of the second crevice.

For the case, that both sealants, that one filling the first crevice and that one filling the second crevice, have the same or nearly the same specific weight, the weight amount is a suitable measure to differ between the two sealants.

The amount of the sealant is the quantity of sealant used for filling the clearance. The amount or the quantity could be given in weight amount but with respect to different specific weights of different sealant materials instead of the weight amount the volume of the sealant filling the crevice is used to define the amount of sealant. So the volume of the first sealant in the first clearance is less than the volume of the second sealant in the second clearance. Thus material could be reduced at one side of the burner.

By filling level the ratio of unfilled portion of the crevice and filled portion of the crevice is meant in the sense of the present invention. A filling level of 100% would be equivalent to a completely filled crevice, whereby a filling level of 50% would be a crevice, which is only half filled by a sealant, so that the volume of the filled portion of the crevice equals the volume of the unfilled portion of the crevice.

As mentioned before it is not necessary to achieve a filling level of 100% for obtaining a gas tight burner. It is rather important that a cross-sectional area of the crevice is completely filled with a sealant. The position of the sealant could be everywhere inside the crevice but preferably is as close as possible to the inner end opening.

In a further embodiment of the present invention the cross-sectional area of the first end opening is smaller than the cross-sectional area of the second end opening. For example, if the cross-sectional area of the first end opening and the second end opening is circular, and the diameter of the cross-sectional area of the second end opening is 500 μm and the diameter of the cross-sectional area of the first end opening is 300 μm the ratio can be calculated according the following formula:

$$ratio = \frac{{( 300 µ m )}^{2}}{{( 500 µ m )}^{2}} \cdot 100 \% = 36 \% , that means the cross \text{-} sectional area of$$

the first end opening is 36% of the cross-sectional area of the second end opening.

To achieve an asymmetric ceramic metal halide burner, the two end openings can differ in form, so that an asymmetry is obtained, wherein the other components of the discharge burner do not differ. It is possible, that the cross-sectional area of the second end opening is larger or smaller than the cross-sectional area of the first end opening and in case of differences between other components on the first and second side of the ceramic metal halide burner, both cross-sectional areas could also be the same. It is preferable, that the cross-sectional area of the first end opening is equal to the cross-sectional area of the second end opening, whereby the cross-sectional areas are as small as possible, preferably the cross-sectional areas of the end openings are as large as the corresponding cross-sectional area of the feed throughs. But as mentioned before it could be useful that the cross-sectional area of the second end opening is larger than the cross-sectional area of the first end opening because of the filling. If the filling comprises a salt pellet with a diameter preferably in the range of ≧100 μm to ≦600 μm, more preferably from ≧200 μm to ≦500 μm, and most preferably from ≧250 μm to ≦450 μm, and a circular shaped cross-sectional area of the first end opening is realized, the cross-sectional area of the second end opening can be larger than the cross-sectional area of the first end opening. This of course also leads to an asymmetric setup of the ceramic metal halide burner.

Another component in which the two sides of the discharge burner could differ is the feed through. The feed through comprises at least an electrode and a rod part.

In another embodiment of the present invention one of the feed throughs is constructed of more parts of components than the other one of the feed throughs, preferably one of said feed throughs comprises at least two, more preferably three, and most preferably four parts of components; and/or the largest cross-sectional area of one of the feed throughs is larger than the largest cross-sectional area of the other one of the feed throughs, and/or the rod and/or electrode length of one of the feed throughs is shorter than the rod and/or electrode length of the other one of the feed throughs.

Preferably the first feed through comprises at least three electrode feed through parts: an electrode for achieving a discharge arc positioned inside the discharge cavity, a main body surrounded by the end opening being in contact with the sealant, and an extending part positioned outside the end part. Different electrode feed through parts are distinguishable from each other by their different materials and/or dimensions. A two-part electrode-feed through-combination comprises for example a W electrode and a Mo or Re rod connected to the W electrode by welding. A three-part electrode-feed through-combination comprises for example a W electrode position inside the discharge cavity, a cermet rod positioned in the end part for a smaller part covered with a sealing frit, and a Nb rod partly inside the end part, covered with a sealing frit and partly outside the end part.

Preferably the first feed through according to the present invention comprises a main body that consists of at least two main body parts, which are aligned, in one line. The two main body parts are made of different materials and/or have different dimensions. The main body part being in contact or comes in contact with the discharge arc has to be resistant against the filling. Therefore at least the main body part located closer to the discharge cavity—or the inner main body part—is made of a material that withstands the filling. The part located nearer to the outside or the outer main-body part is made of a material that has at least partly a thermal expansion coefficient matching that one of the discharge vessel, which is made of a material like Al₂O₃. Besides the thermal matching expansion coefficient the outer main body part material has also to be resistant against the filling if it comes in contact with the discharge. This is a more simple alternative to expensive and much more difficult to manufacture gradient cermets. The main body of the feed through can even comprise a third part, which can be different in its geometry from the other parts of the main body. Preferably the third part of the main body is smaller in its geometry building a recess leading to the inside of the discharge cavity for locating a sealant in the recess. The second feed through can be a tested and well-known three-part feed through, because the requirements—as far as they concern the crevice size—for the second side of the ceramic metal halide burner are less high than to the first side. These three part feed throughs comprise an electrode, a main-body, and an extending part, whereby the main-body is not divided into several parts.

In another embodiment of the invention the discharge vessel of the ceramic metal halide burner is constructed such, that the end parts differ in that the length of one of the end parts is larger than the length of the other one of the end parts, so that an asymmetric discharge vessel is obtained. The length of the end part has an influence on the coldest spot temperature of the burner. This coldest spot temperature can be regulated among other opportunities like the size of the end closure construction or additional external or internal heat sinks by the tip to bottom distance, that is the distance from the top of the electrode to the bottom of the discharge vessel. The coldest spot temperature have to be near the first side. This could be achieved by making the first end closure construction larger than the second end closure construction. However the second end closure construction can be longer as the first end closure construction if the coldest spot temperature near the first end is regulated by for instance a larger tip to bottom distance or a heat sink. The final end part length at both sides is therefore mainly determined by the technical possibilities like sealing with furnaces to make a first creviceless or crevice-reduced end closure construction and a second end closure construction with limited crevice.

In another embodiment of the invention the discharge vessel of the ceramic metal halide burner is constructed such, that the volume of the first end part is larger than the volume of the second end part.

In a further embodiment of the invention the discharge vessel of the ceramic metal halide burner is constructed such, that the cross-sectional area of the first end part is larger than the cross-sectional area of the second end part

Preferably the shape of the end part is tubular, with a volume defined by the formula Vₑₚ=l·π·(Rd₂²−Rd₁²), wherein Vₑₚ is the volume of the end part, l is the length of the end part Rd₂ is the outer radius of the end part, and Rd₁ is the inner radius of the end part. In the case that the first end part and the second end part have equal radii, a difference between the first end part and the second end part can only be achieved by different length l.

The length of the second end part is preferably in the range from ≧0.5 mm to ≦12 mm, more preferably from ≧1.0 mm to ≦8.0 mm, and most preferably from ≧2.0 mm to ≦4.0 mm.

The length of the first end part is preferably in the range from ≧0.5 mm to ≦10.0 mm, more preferably from ≧1.0 mm to ≦6.0 mm, and most preferably from ≧2.0 mm to ≦3.0 mm. For example the length of the first end part is 1.5 mm and the length of the second end part is 4.0 mm, then the ratio of both lengths is calculated to

$$\frac{1.5 mm \cdot 100 \%}{4.0 mm} = 37.5 \% ,$$

that means for this example the length of the first end part is 37.5% of the length of the second end part.

Of course an asymmetric ceramic metal halide burner can also be achieved, if the length of the first end part is shorter than the length of the second end part. If a metal or a metal alloy is used as a sealant for sealing the first end closure construction to the first end part, the length of the first end part can be shorter than the length of the second end part. In order to achieve a cold spot in the discharge tube near the first sealing, a larger tip to bottom distance can be realized by application of a longer electrode rod as part of the first feed through than of the second feed through. It is also possible to add a heat sink, for example metal cooling fins connected to the feed through or a current lead wire.

In the case, the end part has a tubular shape; it is also possible, that the inner Radius Rd₁ of the first end part is smaller than the inner Radius Rd₂ of the second end part. In that case, the cross-sectional area of the first end part is larger than the cross-sectional area of the second end part. Preferably the outer Radius Rd₁ of the first end part is the same compared to the outer Radius Rd₂ of the second end part, so that the outer geometry of both end parts is the same and the asymmetric ceramic metal halide burner can be inserted into existing sockets or mountings.

In a further embodiment at least one end part and/or one feed through has a recess extending to the cavity-inside, whereby said recess is at least partly fill able with a corresponding sealant before the sealing process.

Forming a recess in the feed through is an easy way to bring a sealant inside the discharge vessel, so that the sealant later can be melted and thereby filling the unfilled crevice from the inside due to the pressure inside the discharge cavity and due to capillary forces, that force the melted sealant into the unfilled crevice, so that no or only a small unfilled portion of the crevice after the sealing process results. Another way of locating the sealant inside the discharge vessel is to form a recess leading to the discharge cavity in at least one end part before the end part is sintered to the discharge vessel.

More preferably the first end part and/or the first feed through differs from the second end part and/or the second feed through respectively, in that the second end part and/or the second feed through has a recess leading inside the cavity for arranging a sealant therein. In that recess a sealant could be placed, so that during a sealing process, said sealant will melt and flow from the inside into the crevice due to the pressure inside the discharge cavity. Of course it is possible, that the first end part and/or the first feed through has a recess leading inside the cavity for arranging a sealant therein but it is preferred, that a better crevice minimized discharge burner is achieved, if only the second end part and/or the second feed through has a recess.

One advantage is, that the ceramic metal halide burner is operation able with a power preferably being in the range from 5 W to 250 W, more preferably from 8 W to 70 W, and most preferably from 15 W to 35 W, and/or the burner is filled with a pressure inside the discharge vessel preferably being in the range from 1 bar to 40 bar, more preferably from 5 bar to 30 bar, and most preferably from 8 bar to 25 bar at room temperature. During operation this pressure is about 7 times higher.

The pressure inside the discharge vessel and/or the power mentioned before mainly determine the time for running-up the discharge arc. For example a high Xe pressure advantageously creates during the run-up phase of the lamp a higher lamp voltage. As a consequence the lamp power input during the run-up phase of the lamp will be larger at the same run-up current, which is limited by the ballast and the lamp will thus show at this limited current a faster run-up. The power dissipated in the lamp during the run-up phase differs from the aforementioned nominal power during the burning. The run-up phase is the phase, in which the burner reaches a certain light level. A run-up time of the lamp is achieved with a low pressure—that is the filling pressure—preferably being in the range from 5 bar to 10 bar. On the other hand a certain power is necessary to achieve a quick run-up of the burner. This power for running-up the burner is in case of an automotive lamp in the range of 5 W to 40 W. Further a high pressure inside the discharge vessel leads to higher efficacies and lower conduction of heat to the tube walls.

A second aspect of the present invention is to provide a method of manufacturing a crevice-minimized ceramic metal halide burner comprising two feed throughs, one discharge vessel with two end parts having two end openings and a cavity for accommodating a filling, two end closure constructions, and sealants for gas tight connecting said feed throughs with the corresponding end parts of the discharge vessel, whereby the manufacturing method comprises the steps: positioning at least one sealant into said discharge vessel, into a recess of at least one end part, and/or into a recess of at least one feed through, whereby said recess leads to the inside of said discharge vessel, sintering said end parts to the discharge vessel, closing said first end opening by sealing said first end closure construction to said first end part, filling said discharge vessel with an ionizable filling through the remaining end opening, and closing said second end opening by arranging said second feed through in said second end opening and gas-tight connecting said second feed through to said second end part with a second sealant, so that a gas tight ceramic metal halide burner is obtained, whereby preferably at least one sealant fills the crevice from the inside.

Preferably only the second sealing will be done with a sealant positioned into a recess of a feed through. In that case the molten sealant will be pushed by the extending filling, for example Xe, into the crevice.

Such burners are manufactured in the following manner:

The end part with a through-going end opening and the discharge tube, are sintered together. Both, the end part and the discharge tube are preferably made of a polycrystalline-alumina-Al₂O₃ or PCA-material. The first step to close the end opening of the end parts is that the first complete electrode feed through combination or the first end closure construction is inserted in the first end part and a ring of metal alloy is positioned on top of the end part around the feed through part, extending out of the end opening of the end part Preferably the arrangement of the feed through inside the end opening of the end part would lead to a very small clearance or crevice most preferably to a unfilled crevice with a volume as close as possible to 0 mm³. Next, the end part, the feed through and the sealing ring is heated, so that the sealing ring begins to melt and thus fills up the clearance between the feed through and the end part by flowing into the clearance. The resulting or better remaining unfilled crevice after the sealing procedure between end closure construction and end part should have a very small volume preferably a volume in the order of 0 mm³, that is no unfilled crevice exists. To achieve a minimized crevice a metal alloy is applied as a sealant, selected from the group comprising Pt with a small amount of Zr instead of Nb. This material is more resistant against the aggressive metal halide filling at high temperatures. Depending on the material of the feed through this filling material does not attack certain feed through materials. In case of for example a Nb feed through material the filling attacks the feed through, so that other means for avoiding that attack have to be installed. The resistance of metal alloy against halides depends on its composition. The composition is not free choose able. In case of a use as a filling for a burner the Pt—Nb metal alloy has to be sufficient noble because otherwise Nb will disappear out of the sealant in areas being in contact with the discharge tube filling. Besides depending on composition one can say, that generally a metal alloy is more resistant than standard sealing frits.

In order to obtain a minimized unfilled crevice after the sealing process the metal alloy has to fill the whole cross-section of the crevice or alternatively the whole crevice, which makes it later impossible for salt to creep into a crevice building deposits and cause colour instabilities. To achieve a gas-tight connection, the melting process is done under an Ar environment in a glove box. The sealing time is relatively long and can take from ≧2 s to ≦600 s for example 4 s, preferably from ≧5 s to ≦60 s for example 10 s, and most preferably from ≧15 s to ≦30 s for example 20 s.

The sealing time depends mainly on which temperatures are used, which heating up and cooling down periods are preferred with respect to chemical reactions at certain temperature-levels during certain periods of time and building up of stress in the materials.

The first sealing—that one preferably with a metal or a metal alloy—can be done slowly because of no gas counter pressure in the discharge tube.

After the first sealing, that is sealing the first end closure construction to the first end part, is done, the burner or more precisely the discharge vessel or rather the discharge cavity is filled with a filling comprising a salt. The filling process is also done under an Ar environment.

The filling process is described in the following more detailed:

The discharge cavity is filled with salt pellets through the second end opening of the second end part before the second end closure construction is arranged therein. The pellets are, as mentioned before essentially ball-like and have a diameter that is preferably in the range of ≧100 μm to ≦600 μm for example 150 μm, more preferably in the range of ≧200 μm to ≦500 μm for example 250 μm, and most preferably in the range of ≧250 μm to ≦450 μm for example 310 μm.

Finally the second sealing is made to achieve a gas tight discharge burner. This sealing is done under a high Xe pressure. The pressure of the Xe is preferably in the range from ≧1 bar to ≦40 bar, more preferably from ≧5 bar to ≦30 bar, and most preferably from ≧8 bar to ≦25 bar at room temperature. To avoid expansion of the Xe in the vessel due to the sealing process with an Omega or linear furnace this sealing has to be done as fast as possible. The sealing time of the second sealing has to be short to avoid the heating of the Xe in the discharge vessel as much as possible. The second sealing time is in the range of ≧0.1 s to ≦10.0 s, preferably form ≧0.5 s to ≦5.0 s, and most preferably form ≧1.0 s to ≦2.5 s.

To realize a good sealing, that is a gas tight, long durable sealing, a certain end part length will be necessary with a sufficiently large distance from the vessel filled with Xe. A sufficiently length lies preferably in the range from ≧1 mm to ≦40 mm, more preferably from ≧5 mm to ≦20 mm, and most preferably from ≧8 mm to ≦15 mm and is necessary to avoid too much heating up of the Xe.

The sealant for the second sealing process can be positioned at different areas. The sealant can be either positioned in a recess either in the end part, the discharge vessel, or the feed through. Preferably the sealant is melted inside the discharge vessel, so that the melted sealant flows from the inside to the outside of the discharge vessel due to the pressure in the inside of the discharge vessel. In case of a sealant positioned outside the discharge vessel like by using a sealing frit ring on top of the end part around the extending second feed through, the frit is melted by heating and flows into the crevice due to capillary forces. To realise a short sealing time, the sealing frit is made of a material with a low melting point. By fast heating up of this low melting frit a sufficiently long sealing area can be achieved, whereby only a minor influence of counter pressure from the Xe is measurable. A sufficiently long sealing frit length lies preferably in the range from ≧1.0 mm to ≦8.0 mm, more preferably from ≧1.5 mm to ≦4.0 mm, and most preferably from ≧2.0 mm to ≦3.0 mm, so that a gas tight burner can be achieved.

In case of using a sealant made of a metal or a metal alloy, that has a higher melting temperature than a frit, around the feed through inside the end part, the heating has to be done in a very short time, and the heating has to be a local heating. The time for heating a metal or a metal alloy positioned inside the end part lies preferably between ≧0.1 s and ≦600.0 s, more preferably between ≧5.0 s and ≦100 s, and most preferably between ≧10.0 s and ≦60 s. The melted metal is than forced into the clearance or the unfilled crevice due to the expanding Xe.

Preferably the lamp for lighting purposes, especially a head lamp or a lamp for usage in one of the following applications: shop lighting, home lighting, accent lighting, spot lighting, theater lighting, consumer TV applications, fiber-optics applications, and projection systems comprises at least one ceramic metal halide burner.

A lamp according to the sense of the invention preferably is a lamp with a power between ≧5 W and ≦250 W, more preferably between ≧8 W and ≦70 W, and most preferably between ≧10 W and ≦35 W. Typical a lamp for use in the automotive sector works with a power of around 30 W. The lamp works preferably with a voltage between ≧20 V and ≦120 V, more preferably between ≧30 V and ≦70 V, and most preferably between ≧35 V and ≦65 V.

By using a ceramic metal halide with the abovementioned features the lamp has a more higher colour stability which should lead to a longer durability and further has smaller dimensions.

The shortest end closure construction is limited by the shortest distance between tip of electrode to the distal end of the end closure construction. The end closure construction will be positioned at the top of the lamp. This will lead to the shortest possible lamp, because the light center length, that is the distance between the middle of the discharge arc to a reference plane on a socket of the lamp, is a prescribed value. This prescribed value differs according to the application the lamp is used for. The above mentioned is preferably valid for automotive quartz burners. For ceramic automotive burners the prescribed value can be standardized at a different value.

These and other aspects of the invention will be apparent from and elucidated with reference to the embodiments described hereinafter.

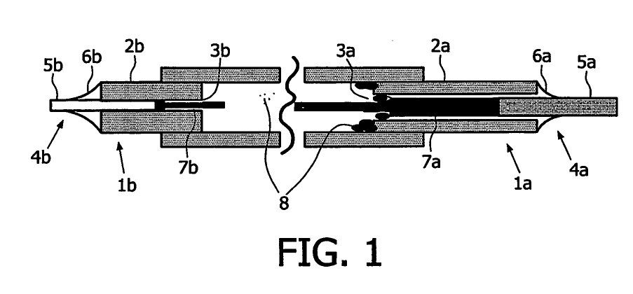

FIG. 1 shows a cross-sectional view of two areas of a ceramic metal halide burner;

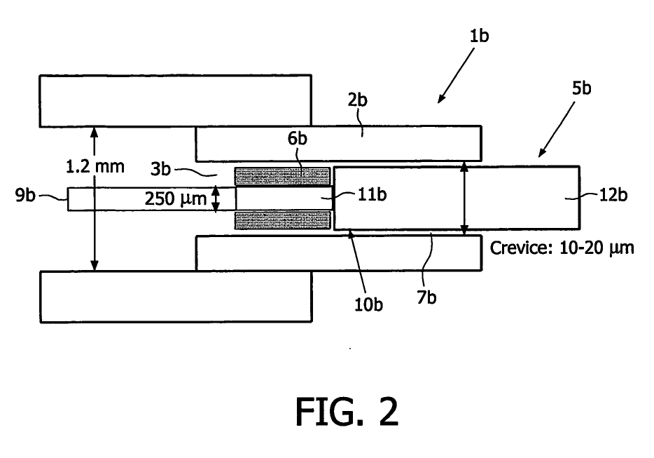

FIG. 2 shows an enlarged cutout in cross-sectional view of a second side of a ceramic metal halide burner; and

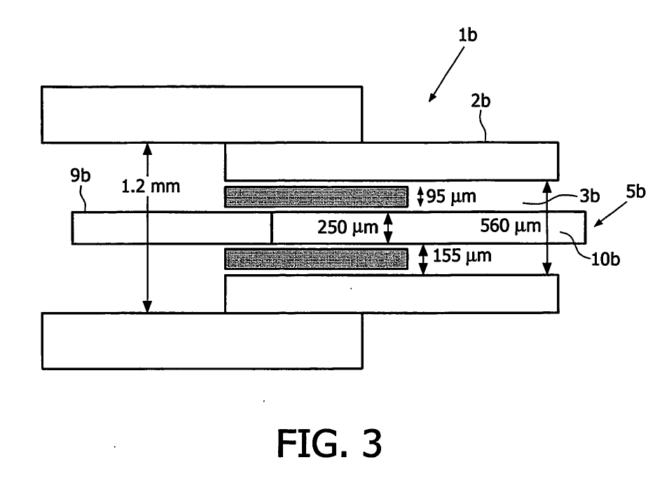

FIG. 3 shows an enlarged cutout in cross-sectional view of a second side of a ceramic metal halide burner feed through.

FIG. 1 depicts two cut-outs of a cross-section of a ceramic metal halide burner showing a first side 1a and a second side 1b of said ceramic metal halide burner. The first side 1a, shown on the right side of the figure, shows a section of the discharge vessel to which a first end part 2a is connected. Both, the section of the discharge vessel and the first end part 2a have a tubular shape, whereby the first end part 2a has a first end opening 3a, which extends along the center-line. The outer diameter of the first end part 2a before the sintering process is smaller than the inner diameter of the section of the discharge vessel, so that the first end part 2a could be arranged partly inside the section of the discharge vessel being completely surrounded by the discharge vessel, with their center-lines aligning. After the sintering process the outer diameter of the end part 2a—or in FIG. 1 the extended plug—is equal or slightly larger than the inner diameter of the section of the discharge vessel, that is the section of the discharge vessel shrinks around the end part. Both, the discharge vessel and the first end part 2a are connected together by means of sintering. The first end part 2a has a first through-going end opening 3a with a circular shaped cross-section. In order to achieve a gas tight burner, the end opening 3a is closed by a first end closure construction 4a. The first end closure construction 4a comprises a first feed through 5a, and a first sealant 6a. The first feed through 5a comprises an electrode, and a main-body consisting of several parts, whereby all parts are aligned along its central line, so that an essentially cylindrical feed through results. The first feed through 5a is partly arranged in the first end opening 3a so that the first feed through 5a extends on both sides of the first end part 2a, either to the inside of the discharge vessel and either to the outside of the discharge vessel. The main part or the main-body of the first feed through 5a is thus circumferentially surrounded by the first end part 2a. Between the first end part 2a and the first feed through 5a before being sealed together exists a small gap, a so-called clearance or a first crevice 7a. The first crevice 7a is filled by a first sealant 6a which at least partly fills the first crevice 7a, whereby an a gas tight connection between first feed through 5a and first end part 2a is achieved.

The first sealant is made of a material selected from the group comprising a metal, a metal alloy and/or a sealing flit. The sealing frit has to be a high melting sealing frit and/or a sealing frit with a high content of Al₂O₃ withstanding the metal halide fillings under high temperatures. The vessel and the end parts 2a, 2b are made of a material comprising a poly crystalline ceramics material. In FIG. 1 the first crevice 7a is completely filled with said first sealant 6a, so that a first unfilled crevice 7a after the sealing process with a volume of about 0 mm³ results. Thus the first side 1a of the discharge burner is the crevice-less side where the salt (shown as black dots) will lay down.

On the left side of the figure a second side 1b of the ceramic metal halide burner is shown. The second side 1b has a similar set-up compared to the first side 1a. At the second side a section of a discharge vessel is shown, to which a second end part 2a with a through-going second end opening 3a is sintered. The second end part 2b has a similar shape as the first end part 2a but is shorter in length and has a smaller second end opening 3b compared to the first end opening 3a, that is the diameter of the second end opening 3b, having a circular shaped cross-section is smaller than the diameter of the first end opening 3a. Thus the second feed through 4b, which has a similar set up compared to the first feed through 4a and which is arranged in said second end opening 3b has a smaller diameter to fit into the smaller second end opening 3b. The crevice between second feed through 5b and second end part 2b is only partly filled after the sealing process, so that a second crevice 7b with a volume larger than the volume of the first crevice 7a results.

The filling 8 is arranged inside the discharge cavity, whereby salts mainly lay down at the first side 1a due to the asymmetry of the discharge burner.

The cutout of the ceramic metal halide burner according to FIG. 1 is in a state after the sealing process. The first crevice 7a is completely filled by the first sealant 6a, which is in this case a PtNb sealant. The second crevice 7b is not completely filled with the second sealant 6b, which is a standard sealant like an Al₂O_{3—Dy}₂O₃—SiO₂— sealant. Although the second crevice 7b is not completely sealed, the filling, shown as black dots, is kept at the first side 1a, which has no crevice. To fill the first crevice 7a completely it is necessary, that no filling is inside the discharge vessel before the first sealing process takes place. Only without the filling long sealing times and high temperatures, which are necessary for using PtNb as a sealant are possible. Alternatively a noble gas like Ar can be used instead of the final filling.

The process of producing a completely filled crevice is very difficult.

One possible solution for achieving a completely filled crevice is shown in FIG. 2.

FIG. 2 shows an enlarged cutout in cross-sectional view of a second side 1b of a ceramic metal halide burner. The cutout shows a tubular second end part 2b, which is connected to a tubular area of the discharge vessel. The second end part 2b has a second through-going end opening 3b, which has a circular shaped cross-section. A second multipart feed through 5b is arranged in said second end opening 3b extending to the discharge cavity and the outside of the burner. The second feed through 5b comprises a second electrode rod 9b, and a second main-body 10b. Both, the second electrode rod 9b and the second main-body 10b are arranged adjacently with their centerlines aligning. The second end part 2b surrounds partly the second main-body 10b and the second electrode rod 9b of the second feed through 5b. The second electrode rod 9b has a circular shaped cross-section with a diameter of about 250 μm. The second main-body 10b comprises two cylindrical parts, which are aligned concentrically to the centerline of the second feed through 5b. The first cylindrical part is the second inner part 11b of the second main-body 10b and the second cylindrical part is the second outer part 12b of the second main-body 10b. The diameter of the second inner part 11b is about 250 μm and the diameter of the second outer part 12b is about 500 μm. Further the second electrode rod 9b of the second feed through 5b is surrounded by a tubular shaped second sealant 6b. The inner diameter of the second sealant 6b is slightly larger than the outer diameter of the second electrode rod 9b, so that the second sealant 6b circumferentially surrounds the second electrode rod 9b, with no or a small clearance between the second sealant 6b and the second electrode rod 9b. The outer diameter of the second sealant 6b is about the same size as or smaller than the outer diameter of the second outer part 12b of the main-body 10b of the second feed through 5b, so that it easily fits into the second end opening 3b. Between the second main-body 10b of the second feed through 5b and the second end part 2b a second crevice 7b exists, which has an annular shaped cross-section with a width of about 10 to 20 μm. FIG. 2 shows a status of the burner before the sealing process. During the sealing process the second sealant 6b is melted and flows from its position into the second crevice 7b and thus fills the second crevice 7b at least partly so that a minimized unfilled second crevice 7b after the sealing process or a maximized filled crevice 7b after the sealing process results.

In order to achieve a completely filled second crevice 7b after the sealing process, the volume of the second sealant 6b before the sealing process has to be larger than or equal to the volume of the unfilled second crevice 7b before the sealing process. It is of importance that the second crevice 7b is filled as close as possible to the second rod electrode 9b. Therefore the second sealant 6b is positioned inside the discharge vessel before the sealing process. When melting, the second sealant 6b is forced to the second crevice 7b by capillary forces and due to the raising pressure inside the discharge vessel caused to by the heating. So the second crevice 7b is sealed from the side being nearest to the discharge cavity. By this way of sealing, the second crevice 7b is first filled at the end being closer to the second electrode rod 9b.

The aforementioned general setup is as well valid for the first side, with the exception, that the geometry of at least one single component and/or the material of at least one single component differ from the geometry and/or the material of the second side 1b.

FIG. 3 shows an enlarged cutout in cross-sectional view of a second side 1b of a ceramic metal halide burner with a second end part 2b having a second end opening 3b. In this embodiment the second end opening 3b having a circular shaped cross-section has a diameter of about 560 μm. The second electrode rod 13b and the second main-body 10b of the second feed through 5b being arranged in said second end opening 3b. Both, second main-body 10b and second electrode rod 13b have a circular shaped cross-section with a diameter of about 250 μm. A tubular shaped second sealant 6b circumferentially surrounds partly the second main-body 12b and the second electrode rod 13b, whereby the second sealant 6b itself is circumferentially surrounded by the second end part 2b, that is the second sealant 6b is sandwich-like arranged between second feed through 5b and second end part 2b. The second sealant 6b having an annular shaped cross-sectional area has an eccentric through-going opening. In this opening the second feed through 5b is located. The width of the second sealant 6b varies from about 95 μm to about 155 μm.

The cutout in FIG. 3 shows a state before the sealing process is completed.

Although FIG. 3 shows a second side 1b of a burner according to the present invention the setup described in FIG. 3 is generally assignable for the first side of said burner.

### List of Reference Numbers

1a first side (of the burner)
1b second side (of the burner)
2a first end part
2b second end part
3a first end opening
3b second end opening
4a first end closure construction
4b second end closure construction
5a first feed through
5b second feed through
6a first sealant
6b second sealant
7a first crevice
7b second crevice
8 filling
9b second electrode rod
10b second main-body
11b second inner part
12b second outer part

1. A metal halide burner with ceramic discharge vessel with
one discharge vessel for accommodating a filling (8) with two end parts (2a, 2b) each having one end opening (3a, 3b),—a filling (8),—a first and a second end closure construction (4a, 4b) having several components for closing said end openings (3a, 3b), and—a first and a second crevice (7a, 7b) between the end openings (3a, 3b) and the end closure constructions (4a, 4b), wherein—the first end closure construction (4a) differs from said second end closure construction (4b) in at least geometry, diameter, length, circumference, cross-sectional area, surface, volume, type of material of the components and/or arrangement of components; and/or—the geometry, diameter, length, circumference, cross-sectional area, surface, volume of said first crevice (7a) differs from the geometry, diameter, length, circumference, cross-sectional area, surface, volume of said second crevice (7b); and/or—the first end part (2a) differs from the second end part (2b) in geometry, diameter, length, circumference, cross-sectional area, surface, volume, type of material of one component, and/or the arrangement of components;—so that an asymmetric ceramic metal halide burner is achieved.

2. The ceramic metal halide burner according to claim 1, wherein the crevices (7a, 7b), each having at least an unfilled portion and a filled portion differ in that—after the sealing process the volume of the unfilled portion of the first crevice (7a) leading to the discharge cavity is smaller than the volume of the corresponding unfilled portion of the second crevice (7b); and/or—the cross-sectional area of said unfilled portion of the first crevice (7a) is smaller than the corresponding cross-sectional area of the unfilled portion of the second crevice (7b); and/or—after the sealing process the length of the unfilled portion of the first crevice (7a) is shorter than the length of the corresponding unfilled portion of the second crevice (7b).

3. The ceramic metal halide burner according to claim 1, wherein the sealants (6a, 6b) differ in that after the sealing process the position of the first sealant (6a) located inside the first crevice (7a) is arranged more closely to the first inner end opening of the first end opening (3a) compared with the position of the second sealant (6b) inside the second crevice (7b), preferably the distance between the first sealant (6a) and the first inner end opening is 0 mm to 2.5 mm, more preferably 0.5 mm to 2.0 mm, and most preferably 0.7 mm to 1.5 mm.

4. The ceramic metal halide burner according to claim 1, wherein the sealants (6a, 6b) differ in that the first sealant (6a) is of a material selected from the group comprising metal or metal alloy and/or—the second sealant (6b) is of a material selected from the group comprising the material of a known sealing frit, a sealing frit with a higher content Al₂O₃ powder than the known sealing frit, Al₂O_{3—Dy}₂O_{3—SiO}₂, and/or—the filling level of the first sealant (6a) after the sealing process inside the filled portion of the first crevice (7a) is larger than the filling level of the second sealant (6b) inside the filled portion of the second crevice (7b).

5. The ceramic metal halide burner according to claim 1, wherein, the feed throughs (5a, 5b) differ in that—the one of the feed throughs (5a, 5b) is constructed of more parts of components than the other one of the feed throughs (5a, 5b), preferably one of said feed throughs (5a, 5b) comprises at least two, more preferably three, and most preferably four parts of components; and/or—the largest cross-sectional area of one of the feed throughs (5a, 5b) is larger than the largest cross-sectional area of the other one of the feed throughs (5a, 5b), and/or—the rod and/or electrode length of one of the feed throughs (5a, 5b) is shorter than the rod and/or electrode length of the other one of the feed throughs (5a, 5b).

6. The ceramic metal halide burner according to claim 1, wherein said discharge vessel is constructed such, that the end parts (2a, 2b) differ in that—the length of one of the end parts (2a, 2b) is larger than the length of the other one of the end parts (2a, 2b) so that an asymmetric discharge vessel is obtained.

7. The ceramic metal halide burner according to claim 1, wherein at least one of the end parts (2a, 2b) and/or at least one of the feed throughs (5a, 5b) has a recess extending to the cavity-inside, whereby said recess is at least partly fill able with a corresponding sealant (6a, 6b).

8. The ceramic metal halide burner according to claim 1, wherein said burner is operation able with a power preferably being in the range from ≧5 W to ≦250 W, more preferably from ≧8 W to ≦70 W, and most preferably from ≧10 W to ≦35 W, and/or the burner is filled with a pressure inside the discharge vessel preferably being in the range from ≧1 bar to ≦40 bar, more preferably from ≧5 bar to ≦30 bar, and most preferably from ≧8 bar to ≦25 bar at room temperature.

9. Method of manufacturing a ceramic metal halide burner according to claim 1, whereby the manufacturing method comprises the steps: i) positioning at least one sealant (6a, 6b) into said discharge vessel, into a recess of at least one end part (2a, 2b), and/or into a recess of at least one feed through (5a, 5b), whereby each recess leads to the inside of said discharge vessel, ii) sintering said end parts (2a, 2b) to the discharge vessel, iii) closing said first end opening (3a) by sealing said first end closure construction (3a) to said first end part (2a), iv) filling said discharge vessel with an ionizable filling (8) through at least one end opening (3a, 3b), and v) closing said second end opening (3b) by arranging said second feed through (5b) in said second end opening (3b) and gas-tight connecting said second feed through (5b) to said second end part (2b) with a second sealant (6b), so that a gas tight ceramic metal halide burner is obtained.

10. Lamp, for lighting purposes, especially a head lamp and/or a lamp for the usage in one of the following applications:—shop lighting,—home lighting,—accent lighting,—spot lighting,—theater lighting,—consumer TV applications,—fiber-optics applications, and—projection systems, comprising at least one ceramic metal halide burner according to claim 1.
